(19) United States
(12) Patent Application Publication
(10) Pub. No.: US 2019/0107627 A1
(43) Pub. Date: Apr. 11, 2019

(54) Optoelectronic Systems

(71) Applicant: Heptagon Micro Optics Pte. Ltd., Singapore (SG)

(72) Inventors: Yibin Tian, Mountain House, CA (US); Hendrik Volkerink, Santa Clara, CA (US)

(21) Appl. No.: 15/999,249

(22) PCT Filed: Feb. 16, 2017
(86) PCT No.: PCT/SG2017/050071

§ 371 Date: Aug. 17, 2018

Related U.S. Application Data
(60) Provisional application No. 62/296,207, filed on Feb. 17, 2016.

(51) Int. Cl. G01S 17/89; G01S 17/02; G06K 9/00; G01S 17/06; G01S 7/481

(52) U.S. Cl. CPC G01S 17/89; G01S 17/023; G06T 2207/10028; G01S 17/06; G01S 7/4817; G06K 9/00362

(57) ABSTRACT

The present disclosure describes an optoelectronic system and methods for efficiently capturing three-dimensional data. The optoelectronic system includes a three-dimensional imaging module and a distance measuring module. Data collected via the distance measuring module is used to collect three-dimensional data, such as three-dimensional maps or other representations of three-dimensional objects. Further, the approach can be extended to multiple regions of interest, and can be applied to the acquisition of biometric data.

### TECHNICAL FIELD

This disclosure relates to optoelectronic modules for distance measurements, and to methods for determining data and biometric data.

### BACKGROUND

Various techniques are available to capture three-dimensional data of objects in a scene using image capture devices. Three-dimensional data may be used in augmented reality technology, for robotics, and for natural user interface technologies (such as eye tracking or gaze detection), for example. Further, three-dimensional data may be used for gaming, and the collection of biometric data (e.g., face and iris recognition data, and facial expression analysis).

Three-dimensional data may be captured with triangulation-based three-dimensional imaging. Triangulation-based three-dimensional imaging includes active and passive stereo techniques, and encoded light techniques. Such techniques employ feature matching.

Stereo techniques require capturing a stereo-image pair (i.e., at least two images taken from different viewpoints separated by a known baseline distance). Corresponding features in the at least two images must be determined to collect three-dimensional data. Block-matching techniques, for example, may be used to determine the corresponding features. Typical block matching technique involve defining one of the at least two images in the stereo-image pair as a reference image and another image as the search image. A block of pixels, exhibiting a particular intensity distribution, is selected within the reference image, and the search image is scanned for the corresponding block (i.e., a block exhibiting the same or substantially the same particular intensity distribution). The position of the corresponding block in the search image relative to the position of the block in the reference image defines a disparity. The disparity, together with the baseline distance and the focal length of the optical system used to collect the reference and search images can be used to determine three-dimensional data. Scanning can be relatively time-consuming and can require significant computational power. Consequently, real-time or near-real time applications involving the block matching technique may be difficult, or impossible, to achieve. Moreover, mobile devices or other personal computers with limited hardware, power, and computational resources may struggle to implement the block matching technique. In some instances, the block matching technique may fail or require additional unnecessary steps to adequately identify a block in images lacking sufficient texture.

Encoded-light techniques is another example of a triangulation-based three-dimensional imaging technique. Encoded-light techniques require an illuminator to generate (e.g., project) a known encoded light pattern onto an object or objects in a scene. The generated pattern is distorted by the objects in the scene. The degree to which the pattern is distortion can correspond to the distance between an object in the scene and the illuminator generating the pattern. An image of the distorted pattern is captured, then a comparison between the known and distorted pattern can be used to collect three-dimensional data of the object or objects in the scene. The image must be scanned for corresponding encoded-light features no unlike the block matching technique mentioned above; consequently, the encoded-light technique can face similar challenges (e.g., scanning can be computationally expensive).

Three-dimensional data is often used for biometric data collection/analysis and behavior analysis, both of which can be widely implemented with mobile devices and personal computers. For example, biometric data may be used for user authentication (such as face or iris recognition). In addition, behavior analysis can be used to augment user interactions with a mobile device or personal computer via such techniques as eye-tracking and facial expression analysis. The previous examples require three-dimensional data, however, the challenges of scanning/searching (e.g., block matching) as described above in connection with triangulation-based techniques can hinder the collection of biometric data and/or the analysis of user behavior.

### SUMMARY

The present disclosure describes optoelectronic systems and methods for collecting three-dimensional data. In one aspect, for example, an optoelectronic system includes a three-dimensional imaging module, a distance measuring module, and a processor. The three-dimensional imaging module includes an intensity imager. The intensity imager includes an array of light-sensitive intensity elements and an optical assembly. The three-dimensional imaging module is operable to collect at least one intensity image of a scene. The distance measuring module includes a first light-emitting component and an array of light-sensitive distance elements. The first light-emitting component is operable to generate a first particular wavelength or range of wavelengths. The array of light-sensitive distance elements is sensitive to the first particular wavelength or range of wavelengths of light generated by the first light-emitting component. The distance measuring module is operable to collect data of the scene. The processor is operable to generate the three-dimensional data from the at least one intensity image and the data collected by the distance measuring module.

Some implementations include one or more of the following features. For example, a dimensional imaging module can include a second light emitting component operable to generate a second particular wavelength or range of wavelengths, and an array of light-sensitive intensity elements sensitive to the second particular wavelength or range of wavelengths generated by the second light emitting component.

In some cases, the second light emitting component is operable to generate a texture onto a scene. Three-dimensional data can be augmented by the texture generated onto the scene.

In some instances, the second light emitting component is operable to generate an encoded light onto a scene. Three-dimensional data can be augmented by the encoded light generated onto the scene.

In some implementations, the first light-emitting component is operable to generate modulated light and the array of light-sensitive distance elements is operable to demodulate modulated light incident on the array of light-sensitive distance elements.

In some cases, an array of light-sensitive intensity elements and an array of light-sensitive distance elements are sensitive to a first particular wavelength or range of wavelengths generated by a first light-emitting component.

The optoelectronic system can include at least one additional intensity imager separated from another intensity imager by a baseline. The at least one additional intensity imager includes an array of light-sensitive intensity elements and an optical assembly.

In some instance, the optoelectronic system includes an array of light-sensitive intensity elements sensitive to a first particular wavelength or range of wavelengths of light generated by a first light-emitting component.

The optoelectronic system includes, in some implementations, a non-transitory computer-readable medium comprising instructions stored thereon. When the instructions are executed by a processor, the following is performed: capturing an intensity image with an intensity imager; establishing a region-of-interest within the intensity image; capturing data with a distance measuring module; mapping the data to a region-of-interest within the intensity image; and generating three-dimensional data with the intensity image and the data.

In some cases, when executed by a processor, the machine-readable instructions cause the following to be performed: capturing an intensity image with an intensity imager; capturing an additional intensity image with at least one additional intensity imager; establishing a region-of-interest within the intensity image or the additional intensity image; capturing data with a distance measuring module; mapping the data to a region-of-interest within the intensity image or the additional intensity image; and generating three-dimensional data with the intensity image and the data such that a block-matching protocol associated with the region-of-interest is augmented by the data.

In some instances, the optoelectronic system implements a method that includes generating three-dimensional data including estimating disparity from data captured by a distance measuring module and augmenting a block-matching protocol with the estimated disparity.

In some cases, the method includes establishing a region-of-interest within an intensity image or an additional intensity image which includes establishing the region-of-interest with an object-recognition protocol.

In some implementations, the method includes establishing a region-of-interest within an intensity image or an additional intensity image which includes establishing the region-of-interest with machine learning.

The optoelectronic system also includes, in some cases, a second light emitting component operable to generate a second particular wavelength or range of wavelengths. An array of light-sensitive intensity elements is sensitive to the second particular wavelength or range of wavelengths generated by the second light emitting component. The second light emitting component is operable to generate a texture onto a scene, and the three-dimensional data is augmented by the texture generated onto the scene.

The first light-emitting component can be operable to generate modulated light. The optoelectronic system can include an array of light-sensitive distance elements operable to demodulate modulated light incident on an array of light-sensitive distance elements.

The optoelectronic system also can include, in some cases, a second light emitting component operable to generate a second particular wavelength or range of wavelengths. An array of light-sensitive intensity elements is sensitive to the second particular wavelength or range of wavelengths generated by the second light emitting component. The second light emitting component is operable to generate an encoded light onto a scene, wherein three-dimensional data is augmented by the encoded light generated onto the scene.

In some instances, the first light-emitting component is operable to generate modulated light, and the array of light-sensitive distance elements is operable to demodulate modulated light incident on the array of light-sensitive distance elements.

In accordance with another aspect, a method includes capturing an intensity image with an intensity imager; establishing a region-of-interest within the intensity image; capturing data with a distance measuring module; mapping the data to the first region-of-interest; and generating the three-dimensional data with the intensity image and the data.

In another aspect, a method includes capturing an additional intensity image with at least one additional intensity image; and generating three-dimensional data with the intensity image and the data such that the block-matching protocol associated with the region-of-interest is augmented by the data.

In some cases, a method for capturing three-dimensional data with an optoelectronic system includes estimating disparity from data captured by a distance measuring module and augmenting a block-matching protocol with the estimated disparity.

Other aspects, features and advantages will be apparent from the following detailed description, the accompanying drawings, and the claims.

### BRIEF DESCRIPTION OF THE DRAWINGS

FIGS. 1A-1C depict an example of an optoelectronic system for collecting three-dimensional data.

FIGS. 2A-2C depict another example of an optoelectronic system for collecting three-dimensional data.

FIGS. 3A-3C depict yet another example of an optoelectronic system for collecting three-dimensional data.

FIG. 4A-4C depict still yet another example of an optoelectronic system for collecting three-dimensional data.

FIG. 5 depicts example process steps for collecting three-dimensional data.

FIG. 6 depicts other example process steps for collecting three-dimensional data.

FIG. 7 depicts still other example process steps for collecting three-dimensional data.

### DETAILED DESCRIPTION

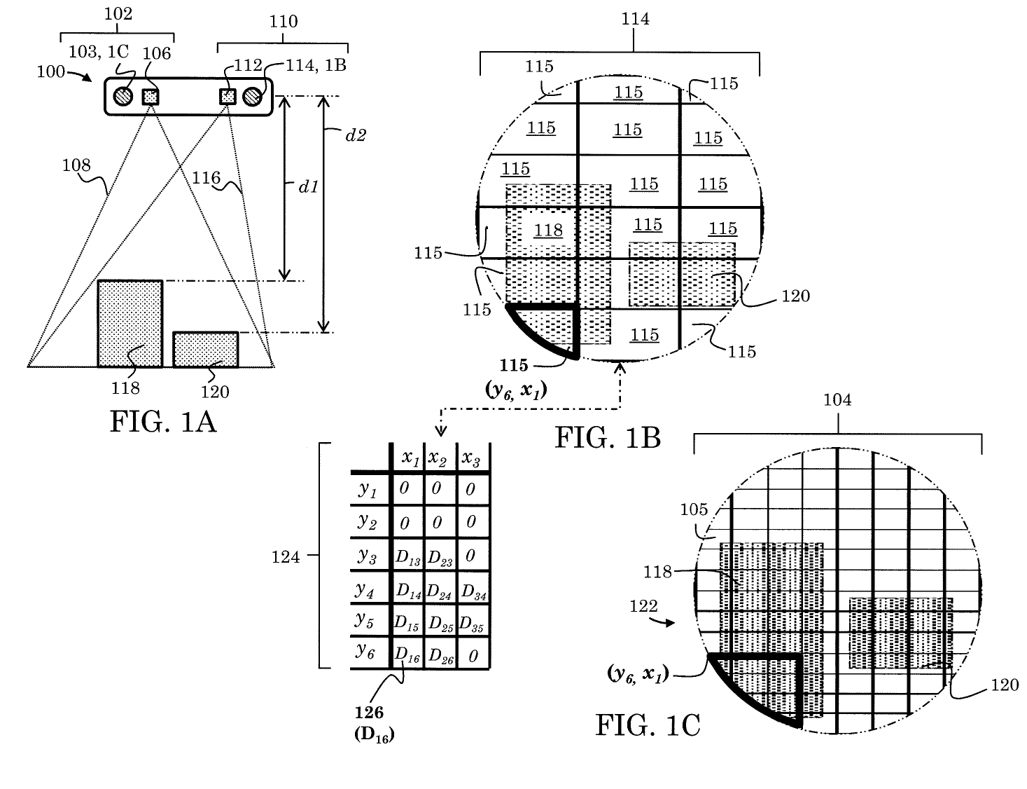

FIG 1A-1C depict an example of an optoelectronic system for collecting three-dimensional data. Three-dimensional data may include, for example, a three-dimensional map or other three-dimensional representation of a region or regions of interest in a scene. The optoelectronic system 100 includes a three-dimensional imaging module 102 and a distance measuring module 110. The optoelectronic system 100 further includes a processor (not depicted) and, in some instances, can include a non-transitory computer readable medium. The processor can be operable to perform operations supporting the three-dimensional imaging module 102 and the distance measuring module 110. Further, the non-transitory computer-readable medium can include machine-readable instructions stored thereon, that when executed by the processor, implement execution of a three-dimensional imaging protocol to acquire three-dimensional data. In some instances, the processor is implemented as part of a central processing unit (CPU) integrated within a host device, such as a smartphone, tablet computer, or laptop computer. In some instances, for example, the processor includes a microprocessor chip, or multiple microprocessor chips associated with the various components of the optoelectronic system 100. Still in some instances, the processor includes drivers, computer code, integrated circuits and other electronic components necessary for the operation of the optoelectronic system 100 as would be apparent to a person of ordinary skill in the art.

The distance measuring module 110 includes a first light-emitting component 112 (e.g., a light-emitting diode, a laser diode, or an array of light-emitting didoes and/or laser diodes) and an array of light-sensitive distance elements 114. The array of light-sensitive distance elements 114 includes one or more light-sensitive elements 115, such as a photodiode, complementary metal-oxide semiconductor (CMOS) and/or charge-coupled device (CCD)-based pixel as depicted in FIG. 1B. The first light-emitting component 112 can be operable to generate a first particular wavelength (e.g., 704 nm, 850 nm, 940 nm) or range of wavelengths 116 (e.g., infrared and/or near infrared light). In some instances, the first light-emitting component 112 is operable to generate substantially diffuse light while in other instances the first light-emitting component 112 is operable to generate encoded light or can be operable to generate texture (e.g., textured light). In some instances, the distance measuring module 110 is operable to collect data via a modulated light technique, such as the indirect time-of-flight technique. For example, the first light-emitting component 112 can be operable to generate modulated light, while the array of light-sensitive distance elements 114 can be operable to collect and demodulate the modulated light.

The distance measuring module 110 can be operable to collect data from a scene including single or multiple regions-of-interest such as a first region-of-interest 118 and an additional region-of-interest 120. In some instances, the first region-of-interest 118 includes a human face, whereas the additional region-of-interest 120 includes an eye or a pair of eyes associated with the human face of the first region-of-interest 118. In some instances, for example, the first region-of-interest 118 includes an eye, whereas the additional region-of-interest 120 includes an iris and/or a pupil. Still other variations are within the scope of this disclosure, for example, multiple additional regions-of-interest 120 are possible. In some instances, both first region-of-interest 118 and the additional region-of-interest 120 may represent two distinct faces. In some instances, the regions-of-interest may be established by predetermining a desired object distance. For example, when a face or iris is at a desired distance d1, the face or iris establishes the first region-of-interest 118. In some instances, the regions-of-interest may be established by facial recognition protocols, object recognition protocols, machine learning or other protocols implemented with the three-dimensional imaging module 102 and the processor, and in some cases the non-transitory computer-readable medium, as disclosed further below.

The data collected from the scene can include distance or proximity to the first region-of-interest 118 and the additional region-of-interest 120. The regions-of-interest, such as the first region-of-interest 118 and the additional region-of-interest 120 can be at different distances from the optoelectronic system 100, represented in FIG. 1A by d1 and d2, respectively, though they need not be at different distances. Light generated from the first light-emitting component 112 can reflect from the regions-of-interest 118, 120 and impinge the array of light-sensitive distance elements 114. FIG. 1B depicts the first region of interest 118 and the additional region-of-interest 120 schematically overlaid onto the array of light-sensitive distance elements 114. Accordingly, the distance measuring module 110 can generate a data array 124 of data values 126 collected from the light-sensitive distance elements 115. The figure is comparable to an image of the regions-of-interest 118, 120, wherein the pixels or other elements used to display the image correspond to the light-sensitive distance elements 115.

For example, in some cases, the first-region of interest 118 reflects light generated by the first light-emitting component 112 which then impinges the light-sensitive distance element 115 located at y₆, x₁ as illustrated in FIG. 1B. The light-sensitive distance element 115 can generate the data value 126 (e.g., a distance value derived from the indirect time-of-flight technique) which is collected within the data array 124 as value D₁₆ schematically illustrated at the bottom of FIG. 1B. A number of data values 126 can be collected until the data array 124 includes a set of useful data values (e.g., multiple data values can be collected from each light-sensitive distance element 115 and then averaged) as would be apparent to a person of ordinary skill in the art. In some instances, the data array 124 can be saved to the non-transitory computer readable medium. Further, in some instances, the processor may perform operations or execute steps to manipulate each data value 126 or the data array 124 (e.g., interpolation, averaging, and filtering) as would be apparent to a person of ordinary skill in the art. The data array 124 can be used, in conjunction with the three-dimensional imaging module 102, to rapidly collect three-dimensional data as discussed further below.

The three-dimensional imaging module 102 includes an intensity imager 103. The intensity imager 103 can include an optical assembly (not depicted) and an array of light-sensitive intensity elements 104 as depicted in FIG. 1C. The array of light-sensitive intensity elements 104 includes one or more light-sensitive elements 105, such as photodiodes, CMOS, and/or CCD-based pixels. In some instances, the number of light-sensitive elements 105 can be significantly greater than the light-sensitive distance elements 115. For example, the number of light-sensitive elements 105 can number in the thousands or millions while the number of light-sensitive distance elements 115 can number in the single digits (e.g., three or nine) to the hundreds.

The three-dimensional imaging module 102 further includes a second light-emitting component 106 (e.g., a light-emitting diode, a laser diode, or an array of light-emitting didoes and/or laser diodes). The second light-emitting component 106 can be operable to produce a second particular wavelength (e.g., 704 nm, 850 nm, 940 nm) or range of wavelengths 108 (e.g., infrared and/or near infrared light). In some instances, the second light-emitting component 106 is operable to generate substantially diffuse light, whereas in other instances the second light-emitting component 106 is operable to generate encoded light and or generate texture (e.g., textured light).

The light-sensitive intensity elements are sensitive to at least the second particular wavelength or range of wavelengths 108 generated by the second light-emitting component 106. In some instance, the intensity imager 103 includes a spectral filter or multiple spectral filters (e.g., dielectric and/or dye spectral filters) that substantially attenuate all wavelengths other than the second particular wavelength or range of wavelengths 108. In some instances, the light sensitive intensity elements 105 are sensitive to the first and second particular wavelengths or range of wavelengths 116, 108, respectively. In some instance, the intensity imager 103 includes a spectral filter or multiple spectral filters (e.g., dielectric and/or dye spectral filters) that substantially attenuate all wavelengths other than the first and second particular wavelength or range of wavelengths 116, 108, respectively.

The three-dimensional imaging module 102 is operable to collect three-dimensional imaging data of the scene composed of single or multiple regions-of-interest such as the first region-of-interest 118 and the additional region-of-interest 120. The intensity imager 103 can collect an intensity image 122 or multiple intensity images. Similar to the data array 124, intensity values or signals collected from each of the light-sensitive elements 105 can contribute to the intensity image 122 schematically overlaid onto the array of light-sensitive elements 104 as depicted in FIG. 1C. Moreover, multiple intensity values or signals can be collected until the intensity image 122 is suitable for further analysis or processing (e.g., multiple intensity values or signals can be collected from each light-sensitive element 105 and then averaged) as would be apparent to a person of ordinary skill in the art. In some instances, the intensity image 122 is saved to the computer readable medium (e.g., computer memory). Further, in some instances, the processor may perform operations or execute steps to manipulate each intensity value or multiple intensity images 122 (e.g., interpolation, averaging, and filtering) as would be apparent to a person of ordinary skill in the art. Further, in some instances, the first region-of-interest 118 and the additional region-of-interest 120 are established by object recognition protocols and/or by machine learning.

Three-dimensional data can be collected rapidly by using the intensity image 122 collected from the three-dimensional imaging module 102 and the array of data 124. That is data collected by the three-dimensional imaging module 102 can be augmented by the data collected by the distance measuring module 110. For example, data value 126 (e.g., D₁₆) could indicate that a face or iris is at a desired distance (e.g., d1), thereby establishing the first region-of-interest 118. Data values 126 corresponding to each light-sensitive element 115 can be correlated (e.g., mapped) with a light-sensitive intensity element 105 or a group of light-sensitive intensity elements 105. The correlation would require information about both the three-dimensional imaging module 102 and the distance measuring module 110, such as the focal length of an optical assembly (if incorporated into the intensity imager 103), the dimensions of the array of light-sensitive intensity elements 104, and the dimensions of the array of light-sensitive distance elements 114 as would be apparent to a person of ordinary skill in the art. Accordingly, those light-sensitive intensity elements 105 correlated with the light-sensitive elements 115 capturing data values 126 within the desired distance (e.g., d1) can establish the first region-of-interest 118 within the intensity image 122. Consequently, if further processing of the intensity image 122 is required (e.g., block matching), only that portion of the intensity image 122 corresponding to the desired distance (e.g., d1) need be involved in the further processing, thereby minimizing the amount of time needed to further process the intensity image 122.

In addition to the collection of three-dimensional data, various components of the optoelectronic system 100 can be operable to execute other protocols or collect additional data. For example, in some instances the first light-emitting component 112 can be used in concert with the intensity imager 104 to perform tasks such as eye tracking or gaze detection. In such instances the first light-emitting component 112 can be tilted with respect to the intensity imager 104 to enhance eye tracking or gaze detection (e.g., to reduce or eliminate direct retinal reflections and/or spectral reflection such as from eye glasses or contact lenses). In such instances the first light-emitting component 112 can be tilted 5° while in other instances the first light-emitting component 112 can be tilted greater than or less than 5° as necessitated by the particular specifications of the optoelectronic system 100 such as the working distance (i.e., the distance of intended use between the optoelectronic module 100 and a user or object, for example).

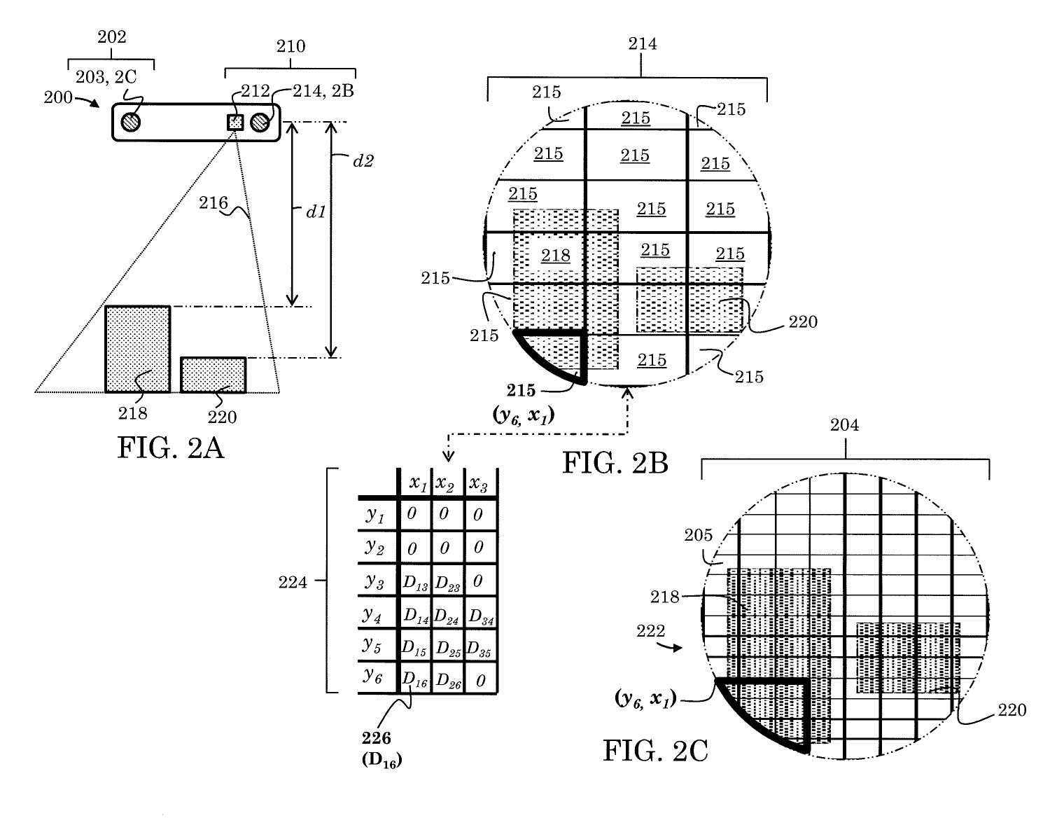

FIG. 2A-2C depict an example of an optoelectronic system for collecting three-dimensional data. Three-dimensional data may include, for example, a three-dimensional map or other three-dimensional representation of a region or regions of interest in a scene. The optoelectronic system 200 includes a three-dimensional imaging module 202 and a distance measuring module 210. The optoelectronic system 200 further includes a processor (not depicted) and, in some instances, can include a non-transitory computer readable medium. The processor can be operable to support operation of the three-dimensional imaging module 202 and the distance measuring module 210 as would be apparent to a person of ordinary skill in the art. Further, the non-transitory computer-readable medium can include machine-readable instructions stored thereon, that when executed by the processor, implement a three-dimensional imaging protocol to acquire three-dimensional data. In some instances, the processor is implemented as part of a central processing unit (CPU) integrated within a host device, such as a smartphone, tablet computer, or laptop computer. In some instances, for example, the processor includes a microprocessor chip, or multiple microprocessor chips associated with the various components of the optoelectronic system 200. Still in some instances, the processor includes drivers, computer code, integrated circuits and other electronic components necessary for the operation of the optoelectronic system 200 as would be apparent to a person of ordinary skill in the art.

The distance measuring module 210 includes a first light-emitting component 212 (e.g., a light-emitting diode, a laser diode, or an array of light-emitting didoes and/or laser diodes) and an array of light-sensitive distance elements 214. The array of light-sensitive distance elements 214 includes one or more light-sensitive elements 215, such as a photodiode, complementary metal-oxide semiconductor (CMOS) and/or charge-coupled device (CCD)-based pixel as depicted in FIG. 2B. The first light-emitting component 212 can be operable to generate a first particular wavelength (e.g., 704 nm, 850 nm, 940 nm) or range of wavelengths 216 (e.g., infrared and/or near infrared light). In some instances, the first light-emitting component 212 is operable to generate substantially diffuse light whereas in other instances the first light-emitting component 212 is operable to generate encoded light or can be operable to generate texture (e.g., textured light). In some instances, the distance measuring module 210 is operable to collect data via a modulated light technique, such as the indirect time-of-flight technique. For example, the first light-emitting component 212 can be operable to generate modulated light, whereas the array of light-sensitive distance elements 214 can be operable to collect and demodulate the modulated light.

The distance measuring module 210 can be operable to collect data from a scene including single or multiple regions-of-interest such as a first region-of-interest 218 and an additional region-of-interest 220. In some instances, the first region-of-interest 218 includes a human face, whereas the additional region-of-interest 220 includes an eye or a pair of eyes associated with the human face of the first region-of-interest 218. In some instances, for example, the first region-of-interest 218 includes an eye, whereas the additional region-of-interest 220 includes an iris and/or a pupil. Still other variations are within the scope of this disclosure, for example, multiple additional regions-of-interest 220 are possible. In some instances, both first region-of-interest 218 and the additional region-of-interest 220 could represent two distinct faces. In some instances, the regions-of-interest may be established by predetermining a desired object distance. For example, when a face or iris is at a desired distance d1, the face or iris establishes the first region-of-interest 218. In some instances, the regions-of-interest may be established by facial recognition protocols, object recognition protocols, machine learning or other protocols implemented with the three-dimensional imaging module 202 and the processor, and in some cases the non-transitory computer-readable medium, as disclosed further below.

The data collected from the scene can include distance or proximity to the first region-of-interest 218 and the additional region-of-interest 220. The regions-of-interest, such as the first region-of-interest 218 and the additional region-of-interest 220 can be at different distances from the optoelectronic system 200, represented in FIG. 2A by d1 and d2, respectively, though they need not be at different distances. Light generated from the first light-emitting component 212 can reflect from the regions-of-interest 218, 220 and impinge the array of light-sensitive distance elements 214. FIG. 2B depicts the first region of interest 218 and the additional region-of-interest 220 schematically overlaid onto the array of light-sensitive distance elements 214. Accordingly, the distance measuring module 210 can generate a data array 224 of data values 226 collected from the light-sensitive distance elements 215. The figure is comparable to an image of the regions-of-interest 218, 220, wherein the pixels or other elements used to display the image correspond to the light-sensitive distance elements 215.

For example, in some implementations, the first-region of interest 218 reflects light generated by the first light-emitting component 212 which then impinges the light-sensitive distance element 215 located at y₆, x₁ as illustrated in FIG. 2B. The light-sensitive distance element 215 can generate the data value 226 (e.g., a distance value derived from the indirect time-of-flight technique) which is collected within the data array 224 as value D₁₆ schematically illustrated at the bottom of FIG. 2B. A number of data values 226 can be collected until the data array 224 includes a set of useful data values (e.g., multiple data values can be collected from each light-sensitive distance element 215 and then averaged) as would be apparent to a person of ordinary skill in the art. In some instances, the data array 224 is saved to the computer readable medium (e.g., computer memory). Further, in some instances, the processor may perform operations or execute steps to manipulate each data value 226 or the data array 224 (e.g., interpolation, averaging, and filtering) as would be apparent to a person of ordinary skill in the art. The data array 224 can be used, in conjunction with the three-dimensional imaging module 202, to rapidly collect three-dimensional data as discussed further below.

The three-dimensional imaging module 202 includes an intensity imager 203. The intensity imager 203 can include an optical assembly (not depicted) and an array of light-sensitive intensity elements 204 as depicted in FIG. 1C. The array of light-sensitive intensity elements 204 includes one or more light-sensitive elements 205, such as photodiodes, CMOS, and/or CCD-based pixels. In some instances, the number of light-sensitive elements 205 can be significantly greater than the light-sensitive distance elements 215. For example, the number of light-sensitive elements 205 can number in the thousands or millions while the number of light-sensitive distance elements 215 can number in the single digits (e.g., three or nine) to the hundreds.

The light-sensitive intensity elements are sensitive to at least the first particular wavelength or range of wavelengths 216 generated by the first light-emitting component 212. In some instance, the intensity imager 203 includes a spectral filter or multiple spectral filters (e.g., dielectric and/or dye spectral filters) that substantially attenuate all wavelengths other than the first particular wavelength or range of wavelengths 216.

The three-dimensional imaging module 202 is operable to collect three-dimensional imaging data of the scene composed of single or multiple regions-of-interest such as the first region-of-interest 218 and the additional region-of-interest 220. The intensity imager 203 can collect an intensity image 222 or multiple intensity images. Similar to the data array 224, intensity values or signals collected from each of the light-sensitive elements 205 can contribute to the intensity image 222 schematically overlaid onto the array of light-sensitive elements 204 as depicted in FIG. 2C. Moreover, multiple intensity values or signals can be collected until the intensity image 222 is suitable for further analysis or processing (e.g., multiple intensity values or signals can be collected from each light-sensitive element 205 and then averaged) as would be apparent to a person of ordinary skill in the art. In some instances, the intensity image 222 can be saved to the computer readable medium (e.g., computer memory). Further, in some instances, the processor may perform operations or execute steps to manipulate each intensity value or multiple intensity images 222 (e.g., interpolation, averaging, and filtering) as would be apparent to a person of ordinary skill in the art. Further, in some instances, the first region-of-interest 218 and the additional region-of-interest 220 are established by object recognition protocols and/or by machine learning.

Three-dimensional data can be collected rapidly by using the intensity image 222 collected from the three-dimensional imaging module 202 and the array of data. That is data collected by the three-dimensional imaging module 202 can be augmented by the data collected by the distance measuring module 210. For example, data value 226 (e.g., D₁₆) could indicate that a face or iris is at a desired distance (e.g., d1), thereby establishing the first region-of-interest 218. Data values 226 corresponding to each light-sensitive element 215 can be correlated (e.g., mapped) with a light-sensitive intensity element 205 or a group of light-sensitive intensity elements 205. The correlation would require information about both the three-dimensional imaging module 202 and the distance measuring module 210, such as the focal length of an optical assembly (if incorporated into the intensity imager 203), the dimensions of the array of light-sensitive intensity elements 204, and the dimensions of the array of light-sensitive distance elements 214 as would be apparent to a person of ordinary skill in the art. Accordingly, those light-sensitive intensity elements 205 correlated with the light-sensitive elements 215 capturing data values 226 within the desired distance (e.g., d1) can establish the first region-of-interest 218 within the intensity image 222. Consequently, provided further processing of the intensity image 222 required (e.g., block matching), only that portion of the intensity image 222 corresponding to the desired distance (e.g., d1) need be involved in the further processing, thereby minimizing the amount of time needed to further process the intensity image 222. Further, in some instances, the data array 224 and the intensity image 222 can be collected as the same time, or substantially the same time, since both the array of light-sensitive intensity elements 204 and the array of light-sensitive distance elements 214 are sensitive to at least the first particular wavelength or range of wavelengths 216 generated by the first light-emitting component 212.

In addition to the collection of three-dimensional data, various components of the optoelectronic system 200 can be operable to execute other protocols or collect additional data. For example, in some instances the first light-emitting component 212 can be used in concert with the intensity imager 204 to perform tasks such as eye tracking or gaze detection. In such instances the first light-emitting component 212 can be tilted with respect to the intensity imager 204 to enhance eye tracking or gaze detection (e.g., to reduce or eliminate direct retinal reflections and/or spectral reflection such as from eye glasses or contact lenses). In such instances the first light-emitting component 212 can be tilted 5° while in other instances the first light-emitting component 212 can be tilted greater than or less than 5° as necessitated by the particular specifications of the optoelectronic system 200 such as the working distance (i.e., the distance of intended use between the optoelectronic module 200 and a user or object, for example).

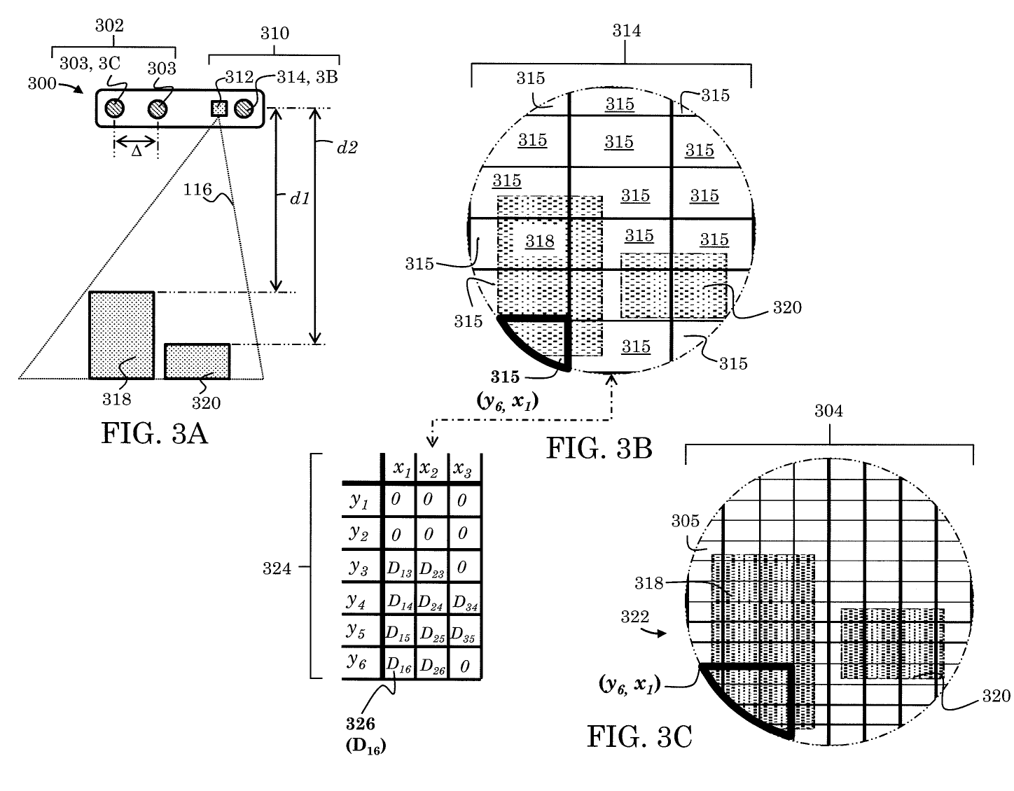

FIG. 3A-3C depict a further example of an optoelectronic system for collecting three-dimensional data. Three-dimensional data can include, for example, a three-dimensional map or other three-dimensional representation of a region or regions of interest in a scene. The optoelectronic system 300 includes a three-dimensional imaging module 302 and a distance measuring module 310. The optoelectronic system 300 further includes a processor (not depicted) and, in some instances, can include a non-transitory computer readable medium. The processor is operable to support the operation of the three-dimensional imaging module 302 and the distance measuring module 310 as would be apparent to a person of ordinary skill in the art. Further, the non-transitory computer-readable medium can include machine-readable instructions stored thereon, that when executed by the processor implement a three-dimensional imaging protocol to acquire three-dimensional data. In some instances, the processor is implemented as part of a central processing unit (CPU) integrated within a host device, such as a smartphone, tablet computer, or laptop computer. In some instances, for example, the processor includes a microprocessor chip, or multiple microprocessor chips associated with the various components of the optoelectronic system 300. Still in some instances, the processor includes drivers, computer code, integrated circuits and other electronic components necessary for the operation of the optoelectronic system 300 as would be apparent to a person of ordinary skill in the art.

The distance measuring module 310 includes a first light-emitting component 312 (e.g., a light-emitting diode, a laser diode, or an array of light-emitting didoes and/or laser diodes) and an array of light-sensitive distance elements 314. The array of light-sensitive distance elements 314 includes one or more light-sensitive elements 315, such as a photodiode, complementary metal-oxide semiconductor (CMOS) and/or charge-coupled device (CCD)-based pixel as depicted in FIG. 3B. The first light-emitting component 312 can be operable to generate a first particular wavelength (e.g., 704 nm, 850 nm, 940 nm) or range of wavelengths 316 (e.g., infrared and/or near infrared light). In some instances, the first light-emitting component 312 is operable to generate substantially diffuse light whereas in other instances the first light-emitting component 312 is operable to generate encoded light or can be operable to generate texture (e.g., textured light). In some instances, the distance measuring module 310 is operable to collect data via a modulated light technique, such as the indirect time-of-flight technique. For example, the first light-emitting component 312 can be operable to generate modulated light, whereas the array of light-sensitive distance elements 314 can be operable to collect and demodulate the modulated light.

The distance measuring module 310 can be operable to collect data from a scene including single or multiple regions-of-interest such as a first region-of-interest 318 and an additional region-of-interest 320. In some instances, the first region-of-interest 318 includes a human face, whereas the additional region-of-interest 320 includes an eye or a pair of eyes associated with the human face of the first region-of-interest 318. In some instances, for example, the first region-of-interest 318 includes an eye, whereas the additional region-of-interest 320 includes an iris and/or a pupil. Still other variations are within the scope of this disclosure, for example, multiple additional regions-of-interest 320 are possible. In some instances, both first region-of-interest 318 and the additional region-of-interest 320 may represent two distinct faces. In some instances, the regions-of-interest may be established by predetermining a desired object distance. For example, when a face or iris is at a desired distance d1, the face or iris establishes the first region-of-interest 318. In some instances, the regions-of-interest may be established by facial recognition protocols, object recognition protocols, machine learning or other protocols implemented with the three-dimensional imaging module 302 and the processor, and in some cases the non-transitory computer-readable medium, as disclosed further below.

The data collected from the scene can include, for example, distance or proximity to the first region-of-interest 318 and the additional region-of-interest 320. The regions-of-interest, such as the first region-of-interest 318 and the additional region-of-interest 320 can be at different distances from the optoelectronic system 300, represented in FIG. 3A by d1 and d2, respectively, though they need not be. In some cases, light generated from the first light-emitting component 312 reflects from the regions-of-interest 318, 320 and impinges the array of light-sensitive distance elements 314. FIG. 3B depicts the first region of interest 318 and the additional region-of-interest 320 schematically overlaid onto the array of light-sensitive distance elements 314. Accordingly, the distance measuring module 310 can generate a data array 324 of data values 326 collected from the light-sensitive distance elements 315. The figure is comparable to an image of the regions-of-interest 318, 320, wherein the pixels or other elements used to display the image correspond to the light-sensitive distance elements 315.

For example, the first-region of interest 318 reflects light generated by the first light-emitting component 312 which then impinges the light-sensitive distance element 315 located at y₆, x₁ as illustrated in FIG. 3B. The light-sensitive distance element 315 can generate the data value 326 (e.g., a distance value derived from the indirect time-of-flight technique) which is collected within the data array 324 as value D₁₆ schematically illustrated at the bottom of FIG. 3B. A number of data values 326 can be collected until the data array 324 includes a set of useful data values (e.g., multiple data values can be collected from each light-sensitive distance element 315 and then averaged) as would be apparent to a person of ordinary skill in the art. In some instances, the data array 324 can be saved to the non-transitory computer readable medium. Further, in some instances, the processor may perform operations or execute steps to manipulate each data value 326 or the data array 324 (e.g., interpolation, averaging, and filtering) as would be apparent to a person of ordinary skill in the art. The data array 324 can be used, in conjunction with the three-dimensional imaging module 302, to rapidly collect three-dimensional data as discussed further below.

The three-dimensional imaging module 302 can be, for example, a stereo camera assembly and can include two or more intensity imagers 303 separated by a baseline distance Δ. The two or more intensity imagers 303 can each include an optical assembly (not depicted) and an array of light-sensitive intensity elements 304 as depicted in FIG. 3C. The array of light-sensitive intensity elements 304 includes one or more light-sensitive elements 305, such as photodiodes, CMOS, and/or CCD-based pixels. In some instances, the number of light-sensitive elements 305 is significantly greater than the light-sensitive distance elements 315. For example, the light-sensitive elements 305 may number in the thousands or millions whereas the light-sensitive distance elements 315 may number in the single digits (e.g., three or nine) or the hundreds.

The light-sensitive intensity elements 305 are sensitive to at least the first particular wavelength or range of wavelengths 316 generated by the first light-emitting component 312. In some instance, the intensity imager 303 includes a spectral filter or multiple spectral filters (e.g., dielectric and/or dye spectral filters) that substantially attenuate all wavelengths other than the first particular wavelength or range of wavelengths 316.

The three-dimensional imaging module 302 is operable to collect three-dimensional imaging data of the scene (e.g., via stereo-image capture) composed of single or multiple regions-of-interest such as the first region-of-interest 318 and the additional region-of-interest 320. The intensity imagers 303 can each collect intensity images 322 or multiple intensity images. Similar to the data array 324, intensity values or signals collected from each of the light-sensitive elements 305 can contribute to the intensity image 322 schematically overlaid onto the array of light-sensitive elements 304 as depicted in FIG. 3C. Moreover, multiple intensity values or signals can be collected until each of the intensity images 322 are suitable for further analysis or processing (e.g., multiple intensity values or signals can be collected from each light-sensitive element 305 and then averaged) as would be apparent to a person of ordinary skill in the art. In some instances, each of the intensity images 322 is saved to the computer readable medium (e.g., computer memory). Further, in some instances, the processor may perform operations or execute steps to manipulate each intensity value or multiple intensity images 322 (e.g., interpolation, averaging, and filtering) as would be apparent to a person of ordinary skill in the art. Further, in some instances, the first region-of-interest 318 and the additional region-of-interest 320 are established by object recognition protocols and/or by machine learning.

Data values 326 corresponding to each light-sensitive element 315 can be correlated (e.g., mapped) with a light-sensitive intensity element 305 or a group of light-sensitive intensity elements 305. The correlation may require information about both the three-dimensional imaging module 302 and the distance measuring module 310, such as the focal length of an optical assembly (if incorporated into the intensity imagers 303), the dimensions of the array of light-sensitive intensity elements 304, and the dimensions of the array of light-sensitive distance elements 314 as would be apparent to a person of ordinary skill in the art.

For example, three-dimensional data can be collected rapidly by using one or more of the intensity images 322 collected from the three-dimensional imaging module 302 and the array of data 324. That is, data collected by the three-dimensional imaging module 302 can be augmented by the data collected by the distance measuring module 310.

In another example, three-dimensional data can be collected rapidly, in some instances, when data value 326 (e.g., D₁₆) indicates that a face or iris is at a desired distance (e.g., d1), thereby establishing the first region-of-interest 318. Accordingly, those light-sensitive intensity elements 305 correlated with the light-sensitive elements 315 capturing data values 326 within the desired distance (e.g., d1) can establish the first region-of-interest 318 within the intensity image 322. Consequently, provided further processing of the intensity image 322 is required (e.g., block matching), only that portion of the intensity image 322 corresponding to the desired distance (e.g., d1) need be involved in the further processing, thereby minimizing the amount of time needed to further process the intensity image 322.

Three-dimensional data can be collected rapidly, in some instances, when block matching is required to determine disparity between two or more intensity images 322. Block matching can be truncated to a particular range within the intensity images 322 by first establishing an estimate of disparity from the array of data 324. Accordingly, the three-dimensional imaging protocol (e.g., based on stereo matching, block matching) can be accelerated effectively and can use fewer computation and/or power resources.

Three-dimensional data can be collected rapidly by using one or more of the intensity images 322 collected from the three-dimensional imaging module 302 and the array of data 324. That is, data collected by the three-dimensional imaging module 302 can be augmented by the data collected by the distance measuring module 310. For example, data value 326 (e.g., D₁₆) could indicate that a face or iris is at a desired distance (e.g., d1), thereby establishing the first region-of-interest 318. Data values 326 corresponding to each light-sensitive element 315 can be correlated (e.g., mapped) with a light-sensitive intensity element 305 or a group of light-sensitive intensity elements 305. The correlation may require information about both the three-dimensional imaging module 302 and the distance measuring module 310, such as the focal length of an optical assembly (if incorporated into the intensity imagers 303), the dimensions of the array of light-sensitive intensity elements 304, and the dimensions of the array of light-sensitive distance elements 314 as would be apparent to a person of ordinary skill in the art. Accordingly, those light-sensitive intensity elements 305 correlated with the light-sensitive elements 315 capturing data values 326 within the desired distance (e.g., d1) can establish the first region-of-interest 318 within the intensity image 322. Consequently, provided further processing of the intensity image 322 is required (e.g., block matching), only that portion of the intensity image 322 corresponding to the desired distance (e.g., d1) need be involved in the further processing, thereby minimizing the amount of time needed to further process the intensity image 322. Further, in some instances, the data array 324 and the intensity images 322 are collected as the same time, or substantially the same time, since both the array of light-sensitive intensity elements 304 and the array of light-sensitive distance elements 314 are sensitive to at least the first particular wavelength or range of wavelengths 316 generated by the first light-emitting component 312.

In addition to the collection of three-dimensional data, various components of the optoelectronic system 300 can be operable to execute other protocols or collect additional data. For example, in some instances the first light-emitting component 312 is used in concert with the intensity imager 304 to perform tasks such as eye tracking or gaze detection. In such instances the first light-emitting component 312 can be tilted with respect to the intensity imager 304 to enhance eye tracking or gaze detection (e.g., to reduce or eliminate direct retinal reflections and/or spectral reflection such as from eye glasses or contact lenses). In such instances the first light-emitting component 312 can be tilted 5° whereas in other instances the first light-emitting component 312 can be tilted greater than or less than 5° as necessitated by the particular specifications of the optoelectronic system 300 such as the working distance (i.e., the distance of intended use between the optoelectronic module 300 and a user or object, for example).

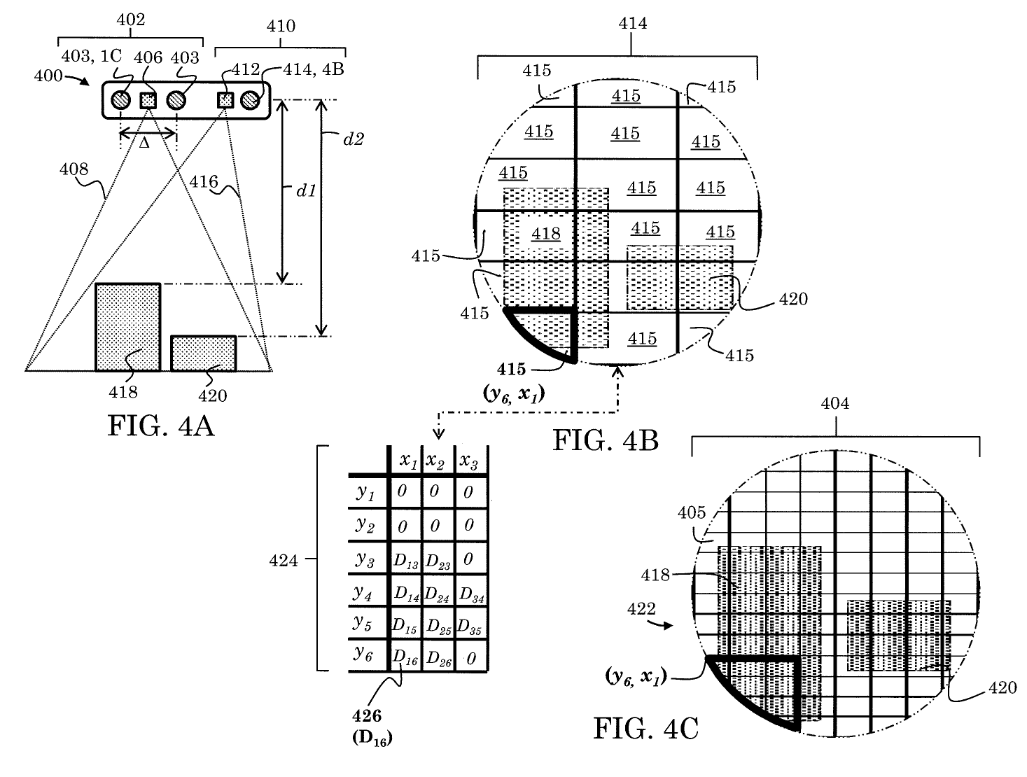

FIG. 4A-4C depict an example of an optoelectronic system for collecting three-dimensional data. Three-dimensional data may include, for example, a three-dimensional map or other three-dimensional representation of a region or regions of interest in a scene. The optoelectronic system 400 includes a three-dimensional imaging module 402 and a distance measuring module 410. The optoelectronic system 400 further includes a processor (not depicted) and, in some instances, can include a non-transitory computer readable medium. The processor can be operable to support operation of the three-dimensional imaging module 402 and the distance measuring module 410 as would be apparent to a person of ordinary skill in the art. Further, the non-transitory computer-readable medium can include machine-readable instructions stored thereon, that when executed on the processor, implement a three-dimensional imaging protocol to acquire three-dimensional data. In some instances, the processor is implemented as part of a central processing unit (CPU) integrated within a host device, such as a smartphone, tablet computer, or laptop computer. In some instances, for example, the processor includes a microprocessor chip, or multiple microprocessor chips associated with the various components of the optoelectronic system 400. Still in some instances, the processor includes drivers, computer code, integrated circuits, and other electronic components necessary for the operation of the optoelectronic system 400 as would be apparent to a person of ordinary skill in the art.

The distance measuring module 410 includes a first light-emitting component 412 (e.g., a light-emitting diode, a laser diode, or an array of light-emitting didoes and/or laser diodes) and an array of light-sensitive distance elements 414. The array of light-sensitive distance elements 414 includes one or more light-sensitive elements 415, such as a photodiode, complementary metal-oxide semiconductor (CMOS) and/or charge-coupled device (CCD)-based pixel as depicted in FIG. 4B. The first light-emitting component 412 can be operable to generate a first particular wavelength (e.g., 704 nm, 850 nm, 940 nm) or range of wavelengths 416 (e.g., infrared and/or near infrared light). In some instances, the first light-emitting component 412 is operable to generate substantially diffuse light whereas in other instances the first light-emitting component 412 is operable to generate encoded light or can be operable to generate texture (e.g., textured light). In some instances, the distance measuring module 410 is operable to collect data via a modulated light technique, such as the indirect time-of-flight technique. For example, the first light-emitting component 412 can be operable to generate modulated light, whereas the array of light-sensitive distance elements 414 can be operable to collect and demodulate the modulated light.

The distance measuring module 410 can be operable to collect data from a scene including single or multiple regions-of-interest such as a first region-of-interest 418 and an additional region-of-interest 420. In some instances, the first region-of-interest 418 includes a human face, whereas the additional region-of-interest 420 includes an eye or a pair of eyes associated with the human face of the first region-of-interest 418. In some instances, for example, the first region-of-interest 418 includes an eye, whereas the additional region-of-interest 420 includes an iris and/or a pupil. Still other variations are within the scope of this disclosure, for example, multiple additional regions-of-interest 420 are possible. In some instances, both first region-of-interest 418 and the additional region-of-interest 420 may represent two distinct faces. In some instances, the regions-of-interest may be established by predetermining a desired object distance. For example, when a face or iris is at a desired distance d1, the face or iris establishes the first region-of-interest 418. In some instances, the regions-of-interest may be established by facial recognition protocols, object recognition protocols, machine learning or other protocols implemented with the three-dimensional imaging module 402 and the processor, and in some cases the non-transitory computer-readable medium, as disclosed further below.

The data collected from the scene can include distance or proximity to the first region-of-interest 418 and the additional region-of-interest 420. The regions-of-interest, such as the first region-of-interest 418 and the additional region-of-interest 420 can be at different distances from the optoelectronic system 400, represented in FIG. 4A by d1 and d2, respectively, though need not be. Light generated from the first light-emitting component 412 can reflect from the regions-of-interest 418, 420 and impinge the array of light-sensitive distance elements 414. FIG. 4B depicts the first region of interest 418 and the additional region-of-interest 420 schematically overlaid onto the array of light-sensitive distance elements 414. Accordingly, the distance measuring module 410 can generate a data array 424 of data values 426 collected from the light-sensitive distance elements 415. The figure is comparable to an image of the regions-of-interest 418, 420, wherein the pixels or other elements used to display the image correspond to the light-sensitive distance elements 415.

For example, the first-region of interest 418 reflects light generated by the first light-emitting component 412 which then impinges the light-sensitive distance element 415 located at y₆, x₁ as illustrated in FIG. 4B. The light-sensitive distance element 415 can generate the data value 426 (e.g., a distance value derived from the indirect time-of-flight technique) which is collected within the data array 424 as value D₁₆ schematically illustrated at the bottom of FIG. 4B. A number of data values 426 can be collected until the data array 424 includes a set of useful data values (e.g., multiple data values can be collected from each light-sensitive distance element 415 and then averaged) as would be apparent to a person of ordinary skill in the art. In some instances, the data array 424 is saved to the computer readable medium (e.g., computer memory). Further, in some instances, the processor may perform operations or execute steps to manipulate each data value 426 or the data array 424 (e.g., interpolation, averaging, and filtering) as would be apparent to a person of ordinary skill in the art. The data array 424 can be used, in conjunction with the three-dimensional imaging module 402, to rapidly collect three-dimensional data as discussed further below.

The three-dimensional imaging module 402 can be a stereo camera assembly and can include two or more intensity imagers 403 separated by a baseline distance Δ. The two or more intensity imagers 403 can each include an optical assembly (not depicted) and an array of light-sensitive intensity elements 404 as depicted in FIG. 4C. The array of light-sensitive intensity elements 404 includes one or more light-sensitive elements 405, such as photodiodes, CMOS, and/or CCD-based pixels. In some instances, the number of light-sensitive elements 405 is significantly greater than the light-sensitive distance elements 415. For example, the light-sensitive elements 405 may number in the thousands or millions whereas the light-sensitive distance elements 415 may number in the single digits (e.g., three or nine) or the hundreds.

The three-dimensional imaging module 402 further includes a second light-emitting component 406 (e.g., a light-emitting diode, a laser diode, or an array of light-emitting didoes and/or laser diodes). The second light-emitting component 406 can be operable to produce a second particular wavelength (e.g., 704 nm, 850 nm, 940 nm) or range of wavelengths 408 (e.g., infrared and/or near infrared light). In some instances, the second light-emitting component 406 is operable to generate substantially diffuse light whereas in other instances the second light-emitting component 406 is operable to generate encoded light and or generate texture (e.g., textured light).

The light-sensitive intensity elements 405 are sensitive to at least the second particular wavelength or range of wavelengths 408 generated by the second light-emitting component 406. In some instances, the intensity imager 403 includes a spectral filter or multiple spectral filters (e.g., dielectric and/or dye spectral filters) that substantially attenuate all wavelengths other than the second particular wavelength or range of wavelengths 408. In some instances, the light-sensitive intensity elements 405 are sensitive to the first and second particular wavelengths or range of wavelengths 416, 408, respectively. In some instance, the intensity imager 403 includes a spectral filter or multiple spectral filters (e.g., dielectric and/or dye spectral filters) that substantially attenuate all wavelengths other than the first and second particular wavelength or range of wavelengths 416, 408, respectively.

The light-sensitive intensity elements are sensitive to the second particular wavelength or range of wavelengths 408 generated by the second light-emitting component 406. In some instance, the intensity imagers 403 include a spectral filter or multiple spectral filters (e.g., dielectric and/or dye spectral filters) that substantially attenuate all wavelengths other than the second particular wavelength or range of wavelengths 408.

The three-dimensional imaging module 402 is operable to collect three-dimensional imaging data of the scene (e.g., via stereo-image capture) composed of single or multiple regions-of-interest such as the first region-of-interest 418 and the additional region-of-interest 420. The intensity imagers 403 can each collect intensity images 422 or multiple intensity images. Similar to the data array 424, intensity values or signals collected from each of the light-sensitive elements 405 can contribute to the intensity image 422 schematically overlaid onto the array of light-sensitive elements 404 as depicted in FIG. 4C. Moreover, multiple intensity values or signals can be collected until each of the intensity images 422 are suitable for further analysis or processing (e.g., multiple intensity values or signals can be collected from each light-sensitive element 405 and then averaged) as would be apparent to a person of ordinary skill in the art. In some instances, each of the intensity images 422 can be saved to the computer readable medium (e.g., computer memory). Further, in some instances, the processor may perform operations or execute steps to manipulate each intensity value or multiple intensity images 422 (e.g., interpolation, averaging, and filtering) as would be apparent to a person of ordinary skill in the art. Further, in some instances, the first region-of-interest 418 and the additional region-of-interest 420 are established by object recognition protocols and/or by machine learning.

Data values 426 corresponding to each light-sensitive element 415 can be correlated (e.g., mapped) with a light-sensitive intensity element 405 or a group of light-sensitive intensity elements 405. The correlation may require information about both the three-dimensional imaging module 402 and the distance measuring module 410, such as the focal length of an optical assembly (if incorporated into the intensity imagers 403), the dimensions of the array of light-sensitive intensity elements 404, and the dimensions of the array of light-sensitive distance elements 414 as would be apparent to a person of ordinary skill in the art.

Three-dimensional data can be collected rapidly by using one or more of the intensity images 422 collected from the three-dimensional imaging module 402 and the array of data 424. That is, data collected by the three-dimensional imaging module 402 can be augmented by the data collected by the distance measuring module 410.

For example, three-dimensional data can be collected rapidly, in some instances, when data value 426 (e.g., D₁₆) indicates that a face or iris is at a desired distance (e.g., d1), thereby establishing the first region-of-interest 418. Accordingly, those light-sensitive intensity elements 405 correlated with the light-sensitive elements 415 capturing data values 426 within the desired distance (e.g., d1) can establish the first region-of-interest 418 within the intensity image 422. Consequently, if further processing of the intensity image 422 is required (e.g., block matching), only that portion of the intensity image 422 corresponding to the desired distance (e.g., d1) need be involved in the further processing, thereby reducing or minimizing the amount of time needed to further process the intensity image 422.

In another example, three-dimensional data can be collected rapidly, in some instances, when block matching is required to determine disparity between two or more intensity images 422. Block matching can be truncated to a particular range within the intensity images 422 by first establishing an estimate of disparity from the array of data 424. Accordingly, the three-dimensional imaging protocol (e.g., based on stereo matching, block matching) can be accelerated effectively and can use fewer computation and/or power resources.

In addition to the collection of three-dimensional data, various components of the optoelectronic system 400 can be operable to execute other protocols or collect additional data. For example, in some instances the first light-emitting component 412 is used in concert with the intensity imager 403 to perform tasks such as eye tracking or gaze detection. In such instances the first light-emitting component 412 can be tilted with respect to the intensity imager 403 to enhance eye tracking or gaze detection (e.g., to reduce or eliminate direct retinal reflections and/or spectral reflection such as from eye glasses or contact lenses). In such instances the first light-emitting component 412 can be tilted 5° while in other instances the first light-emitting component 412 can be tilted greater than or less than 5° as necessitated by the particular specifications of the optoelectronic system 400 such as the working distance (i.e., the distance of intended use between the optoelectronic module 400 and a user or object, for example).

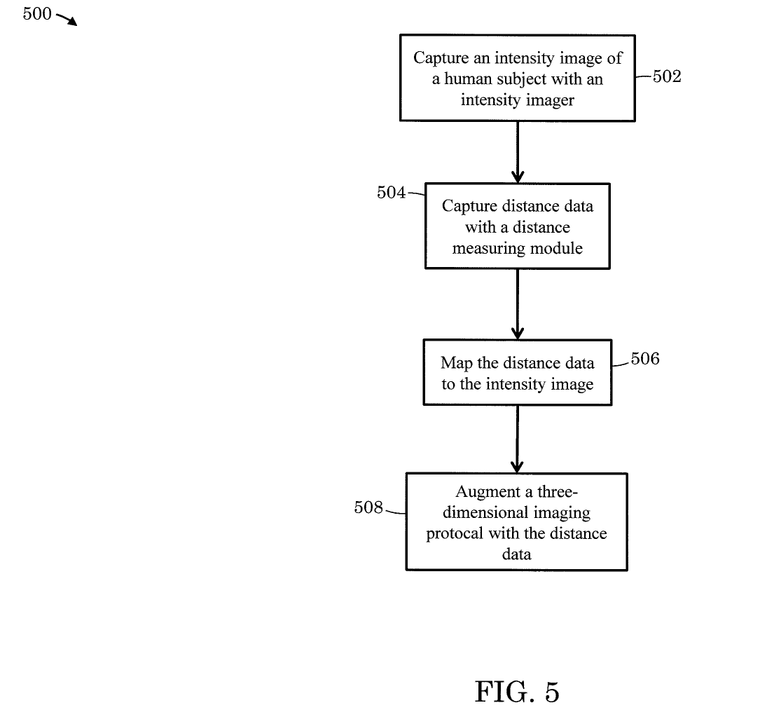

FIG. 5-FIG. 7 depict example processes for the collection of three-dimensional data with the example optoelectronic system 400. However, other optoelectronic systems can use the disclosed example processes, or variants thereof, for the collection of three-dimensional data according to this disclosure as would be apparent to a person of ordinary skill in the art. Moreover, the following example processes can be executed for the collection of biometric data via a three-dimensional imaging protocol augmented by data; however, the process need not be limited to the collection of biometric data. For example, three-dimensional data of objects (not necessarily objects yielding biometric data) in a scene can be collected via the disclosed processes, or variants thereof, as would be apparent to a person of ordinary skill in the art.

FIG. 5 depicts an example process for the collection of three-dimensional data by the example three-dimensional imaging module 402 augmented by the data array 424 collected by the distance measuring module 410. In an intensity image collection operation 502 at least two intensity images 422 of a scene containing objects are captured with the three-dimensional imaging module 402. For example, the second light-emitting component 406 can generate texture in the scene, then each of the two intensity imagers 404 can capture at least one intensity image 422. In some instances, the objects are a human subject. In a data collection step 504, data of the scene containing the three-dimensional objects are captured with a distance measuring module 410. The distance measuring module 410 can collect data via a time-of-flight technique. For example, the first light-emitting component 412 can generate modulated light having a first particular wavelength or range of wavelengths 416. And the array of light-sensitive distance elements 414 can detect and demodulate the incident modulated light. Accordingly, the array of data 424 (e.g., an array of distance values) can be generated.

In a mapping operation 506, the data 424 is mapped to at least one of the intensity images 422. The mapping operation 506 can be executed by using, e.g., calibration data, baseline distances, and optical parameters as would be apparent to a person of ordinary skill in the art. The mapping 506 provides correspondence between at least one of the intensity images 422 and the array of data 424. Accordingly, portions (e.g., a pixel or a plurality of pixels) of the at least one of the intensity images 422 can be associated with portions of the array of data 424. For example, data associated with the light-sensitive distance element 415 located at y₆, x₁ (see FIG. 4B) can be associated with a corresponding portion of one of the intensity images 422 (e.g., the portion highlighted in FIG. 4C).

In an augmentation operation 508, a three-dimensional imaging protocol (e.g., stereo-matching, and block matching) is augmented with the array of data 424. For example, block matching can be executed using the at least two intensity images 422 (i.e., one intensity image can be the reference image, and the other intensity image can be the search image as discussed above). As the block matching protocol is executed in order to determine disparity (and subsequently distance, depth data) via searching/scanning for a matching reference block (i.e., from the reference image) in the search image, the search can be truncated to a particular range by first using the array of data 424 as a first estimate of disparity. Accordingly, the three-dimensional imaging protocol (e.g., based on stereo matching, block matching) can be accelerated effectively and can use fewer computation and/or power resources.

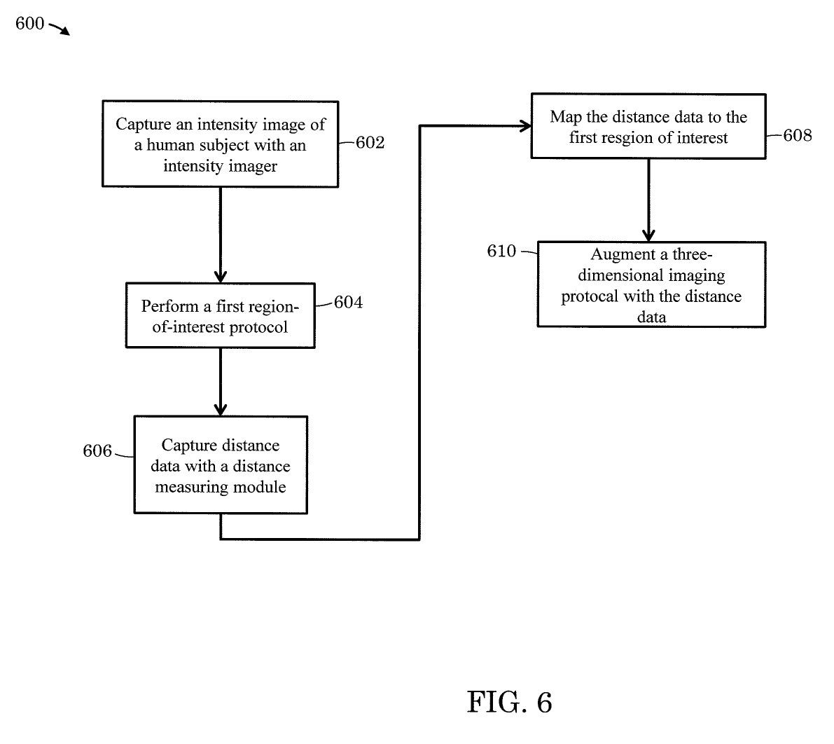

FIG. 6 depicts an example process for the collection of three-dimensional data by the example three-dimensional imaging module 402 augmented by the data array 424 collected by the distance measuring module 410. In an intensity image collection operation 602 at least two intensity images 422 of a scene containing objects are captured with the three-dimensional imaging module 402. For example, the second light-emitting component 406 can generate texture in the scene; then each of the two intensity imagers 404 can capture at least one intensity image 422. In some instances, the objects are a human subject, for example. In a first region-of-interest step 604 the first region-of-interest 418 is established via a first region-of-interest protocol. For example, in some instances, the first region-of-interest 418 is established by object recognition protocols and/or machine learning. In some instances, the first region-of-interest 418 is a face, for example; accordingly, the first region-of-interest protocol can include a face recognition protocol (e.g., an identifying protocol based on features of a human face) in such instances.

In a data collection operation 606, data of the scene containing the objects are captured with a distance measuring module 410. The distance measuring module 410 can collect data via a time-of-flight technique. For example, the first light-emitting component 412 can generate modulated light having a first particular wavelength or range of wavelengths 416. And the light-sensitive distance element 414 can detect and demodulate the incident modulated light. Accordingly, the array of data 424 (e.g., a depth map) can be generated.

In a mapping operation 608, the data 424 is mapped to the first region-of-interest 418 in at least one of the intensity images 422. The mapping operation 608 can be executed by using, e.g., calibration data, baseline distances, and optical parameters as would be apparent to a person of ordinary skill in light of this disclosure. The mapping operation 608 provides correspondence between the first region-of-interest 418 in at least one of the intensity images 422 and the array of data 424. Accordingly, portions (e.g., a pixel or a plurality of pixels) within the first region-of-interest 418 of the at least one of the intensity images 422 can be associated with portions of the array of data 424. For example, data associated with the light-sensitive distance element 415 located at y₆, x₁ (see FIG. 4B) can be associated with a corresponding portion of one of the intensity images 422 (e.g., the portion highlighted in FIG. 4C).

In an augmentation operation 610, a three-dimensional imaging protocol (e.g., including stereo-matching, block matching) is augmented with the array of data 424. Moreover, in the augmentation operation 610, the three-dimensional imaging protocol can be limited to the portions in at least two of the intensity images 422 corresponding to the first region-of-interest 418. For example, block matching can be executed using the portions corresponding to the first region-of-interest 418 within the at least two intensity images 422 (i.e., the first region-of-interest 418 in one intensity image can be the reference image, and the first region-of-interest 418 in the other intensity image can be the search image). As the block matching protocol is executed in order to determine disparity (and subsequently distance, depth data) via searching/scanning for a matching reference block (i.e., from the reference image) in the search image, the search can be truncated to a particular range by first using the array of data 424 as a first estimate of disparity. Accordingly, the three-dimensional imaging protocol (e.g., includes on stereo matching, block matching) can be accelerated effectively and can use fewer computation and/or power resources. In this example, the three-dimensional imaging protocol can be further accelerated because only three-dimensional imaging data of the first region-of-interest 418 (e.g., a human subject's face) is obtained.

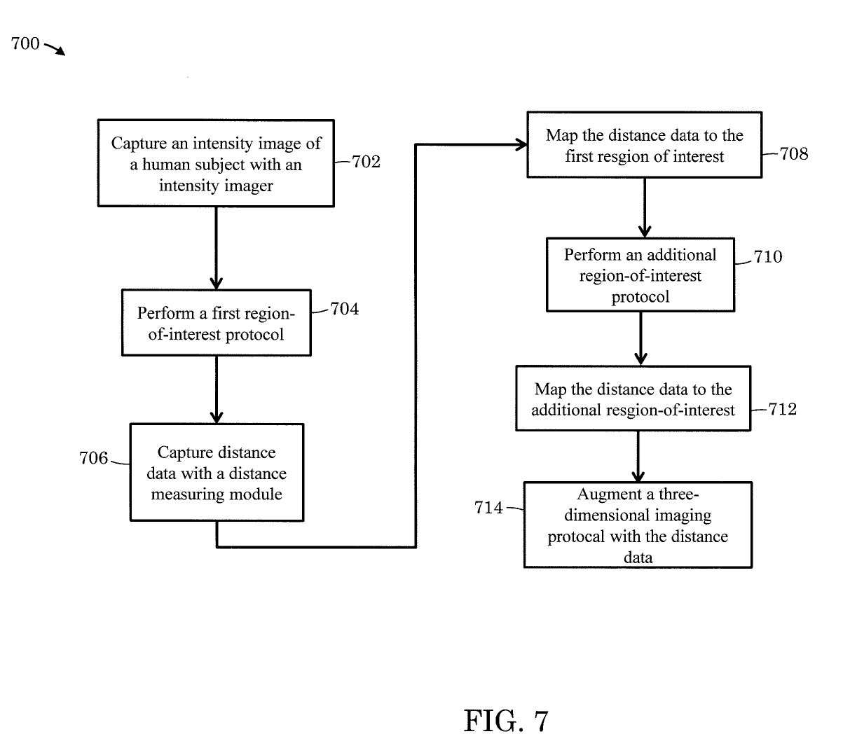

FIG. 7 depicts an example process for the collection of three-dimensional data by the example three-dimensional imaging module 402 augmented by the data array 424 collected by the distance measuring module 410. In an intensity image collection operation 702 at least two intensity images 422 of a scene containing objects are captured with the three-dimensional imaging module 402. For example, the second light-emitting component 406 can generate texture in the scene; then the two intensity imagers 404 can each capture at least one intensity image 422. In some instances, the objects are a human subject, for example. In a first region-of-interest step 704 the first region-of-interest 418 is established via a first region-of-interest protocol. For example, in some instances, the first region-of-interest 418 is established by object recognition protocols and/or machine learning. In some instances, the first region-of-interest 418 is a face, for example; accordingly, the first region-of-interest protocol can include a face recognition protocol (e.g., an identifying protocol based on features of a human face) in such instances.

In a data collection operation 706, data of the scene containing the objects are captured with a distance measuring module 410. The distance measuring module 410 can collect data via a time-of-flight technique. For example, the first light-emitting component 412 can generate modulated light having a first particular wavelength or range of wavelengths 416. And the light-sensitive distance element 414 can detect and demodulate the incident modulated light. Accordingly, the array of data 424 (e.g., a depth map) can be generated.

In a mapping operation 708, the data 424 is mapped to the first region-of-interest 418 in at least one of the intensity images 422. The mapping operation 708 can be executed using, e.g., calibration data, baseline distances, and optical parameters as would be apparent to a person of ordinary skill in light of this disclosure. The mapping 708 provides correspondence between the first region-of-interest 418 in at least one of the intensity images 422 and the array of data 424. Accordingly, portions (e.g., a pixel or a plurality of pixels) within the first region-of-interest 418 of the at least one of the intensity images 422 can be associated with portions of the array of data 424. For example, data associated with the light-sensitive distance element 415 located at y6, x1 (see FIG. 4B) can be associated with a corresponding portion of one of the intensity images 422 (e.g., the portion highlighted in FIG. 4C).

In an additional region-of-interest operation 710 the additional region-of-interest 420 is established via an additional region-of-interest protocol. For example, in some instances, the additional region-of-interest 420 is established by object recognition protocols and/or machine learning. In some instances, the additional region-of-interest 420 is established by using the array of data 424. In some instances, the additional region-of-interest 420 is an eye, an iris, a cornea, and/or a pupil, for example. In another mapping operation 712, the data 424 is mapped to the additional region-of-interest 420 in at least one of the intensity images 422. The mapping operation 712 can be executed using, e.g., calibration data, baseline distances, and optical parameters as would be apparent to a person of ordinary skill in light of this disclosure. The mapping operation 712 provides correspondence between the additional region-of-interest 420 in at least one of the intensity images 422 and the array of data 424. Accordingly, portions (e.g., a pixel or a plurality of pixels) within the additional region-of-interest 420 of the at least one of the intensity images 422 can be associated with portions of the array of data 424. In an augmentation step 714, a three-dimensional imaging protocol (e.g., including stereo-matching, block matching) is augmented with the array of data 424.

Moreover, in the augmentation operation 714, the three-dimensional imaging protocol can be limited to the portions in at least two of the intensity images 422 corresponding to the first region-of-interest 418 and the additional region-of-interest 420. For example, block matching can be executed using the portions corresponding to the first region-of-interest 418 within the at least two intensity images 422 (i.e., the first region-of-interest 418 in one intensity image can be the reference image, and the first region-of-interest 418 in the other intensity image can be the search image). Moreover, block matching can be executed using the portions corresponding to the additional region-of-interest 420 within the at least two intensity images 422 (i.e., the additional region-of-interest 420 in one intensity image can be the reference image, and the additional region-of-interest 420 in the other intensity image can be the search image).

In some instances, parameters used in block matching using portions corresponding to the first region-of-interest 418, and parameters used in block matching using portions corresponding to the additional region-of-interest 420 can be different. For example, in some instances the first region-of-interest 418 corresponds to the face of a human subject, whereas the additional region-of-interest 420 corresponds to the cornea of a human subject. In such instances, it can be an advantage to collect disparity data (via block matching) from the first region-of-interest 418 with coarser parameters (e.g., block size and/or search step) than the additional region-of-interest 420. For example, a large block size and/or large search step could be implemented in the block matching protocol associated with the first region-of-interest 418, whereas a smaller block size and/or smaller search step could be implemented in the block matching protocol associated with the additional region-of-interest 420. Although this example describes parameters associated with active and/or passive stereo three-dimensional imaging techniques, other parameters associated with other three-dimensional imaging techniques, such as encoded-light techniques, can be similarly altered as described above. In such instances, more accurate and/or precise three-dimensional imaging data can be obtained for the additional region-of-interest 420, while less accurate and/or precise three-dimensional data could be obtained for the first region-of-interest 418.

The aforementioned approach can be an advantage when determining, for example, a precise corneal curvature radius, wherein such precision is not necessary for the face (an example of the first region-of-interest 418). As disclosed above, the block matching search can be truncated to a particular range by first using the array of data 424 as a first estimate of disparity. Accordingly, the three-dimensional imaging protocol (e.g., including stereo matching, block matching) can be accelerated effectively and can use fewer computation and/or power resources. In this example, the three-dimensional imaging protocol can be accelerated further because only three-dimensional imaging data of the first region-of-interest 418 (e.g., a human subject's face) and the additional region-of-interest 420 (e.g., a human subject's eye, iris, cornea or pupil) is obtained. Further, the block matching algorithm can be customized to each region of interest, as disclosed above, further accelerating the acquisition of three-dimensional imaging data.

Various aspects of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus” and “computer” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications may be made to the foregoing implementations. Features described above in different implementations may be combined in the same implementations. Thus, other implementations are within the scope of the claims.

1. An optoelectronic system for collecting three-dimensional data comprising:
a three-dimensional imaging module, a distance measuring module, and a processor;
the three-dimensional imaging module including an intensity imager, the intensity imager including an array of light-sensitive intensity elements and an optical assembly, the three-dimensional imaging module being operable to collect at least one intensity image of a scene;
the distance measuring module including a first light-emitting component and an array of light-sensitive distance elements, the first light-emitting component being operable to generate a first particular wavelength or range of wavelengths, the array of light-sensitive distance elements being sensitive to the first particular wavelength or range of wavelengths of light generated by the first light-emitting component, the distance measuring module being operable to collect data of the scene; and
the processor being operable to generate the three-dimensional data from the at least one intensity image and the data collected by the distance measuring module.

2. The optoelectronic system of claim 1, wherein the three-dimensional imaging module further includes a second light emitting component operable to generate a second particular wavelength or range of wavelengths, and wherein the array of light-sensitive intensity elements is sensitive to the second particular wavelength or range of wavelengths generated by the second light emitting component.

3. The optoelectronic system of claim 2, wherein the second light emitting component is operable to generate a texture onto the scene, the three-dimensional data being augmented by the texture generated onto the scene.

4. The optoelectronic system of claim 2, wherein the second light emitting component is operable to generate an encoded light onto the scene, the three-dimensional data being augmented by the encoded light generated onto the scene.

5. The optoelectronic system of claim 1, wherein the first light-emitting component is operable to generate modulated light, and the array of light-sensitive distance elements is operable to demodulate modulated light incident on the array of light-sensitive distance elements.

6. The optoelectronic system of claim 1, wherein the array of light-sensitive intensity elements and the array of light-sensitive distance elements are sensitive to the first particular wavelength or range of wavelengths generated by the first light-emitting component.

7. The optoelectronic system of claim 1, wherein the three-dimensional imaging module further includes at least one additional intensity imager separated from the intensity imager by a baseline, the at least one additional intensity imager including an array of light-sensitive intensity elements and an optical assembly.

8. The optoelectronic system of claim 1, wherein the array of light-sensitive intensity elements are sensitive to the first particular wavelength or range of wavelengths of light generated by the first light-emitting component.

9. The optoelectronic system of claim 1 further including a non-transitory computer-readable medium comprising instructions stored thereon, that when executed by the processor, cause operations to be performed including:
capturing an intensity image with the intensity imager;
establishing a region-of-interest within the intensity image;
capturing the data with the distance measuring module;
mapping the data to the region-of-interest within the intensity image; and
generating the three-dimensional data with the intensity image and the data.

10. The optoelectronic system of claim 7 wherein the non-transitory computer-readable medium further comprises instructions stored thereon, that when executed by the processor, cause operations to be performed including:
capturing an intensity image with the intensity imager;
capturing an additional intensity image with the at least one additional intensity imager;
establishing a region-of-interest within the intensity image or the additional intensity image;
capturing data with the distance measuring module;
mapping the data to the region-of-interest within the intensity image or the additional intensity image; and
generating the three-dimensional data with the intensity image and the data such that a block-matching protocol associated with the region-of-interest is augmented by the data.

11. The optoelectronic system of claim 10, wherein generating the three-dimensional data further includes estimating disparity from the data captured by the distance measuring module and augmenting the block-matching protocol with the estimated disparity.

12. The optoelectronic system of claim 10, wherein establishing a region-of-interest within the intensity image or the additional intensity image includes establishing the region-of-interest with an object-recognition protocol.

13. The optoelectronic system of claim 10, wherein establishing a region-of-interest within the intensity image or the additional intensity image includes establishing the region-of-interest with machine learning.

14. The optoelectronic system of claim 7, wherein the three-dimensional imaging module further includes a second light emitting component operable to generate a second particular wavelength or range of wavelengths, and wherein the array of light-sensitive intensity elements is sensitive to the second particular wavelength or range of wavelengths generated by the second light emitting component, and the second light emitting component is operable to generate a texture onto the scene, the three-dimensional data being augmented by the texture generated onto the scene.

15. The optoelectronic system of claim 14, wherein the first light-emitting component is operable to generate modulated light, and the array of light-sensitive distance elements is operable to demodulate modulated light incident on the array of light-sensitive distance elements.

16. The optoelectronic system of claim 7, wherein the three-dimensional imaging module further includes a second light emitting component operable to generate a second particular wavelength or range of wavelengths, and wherein the array of light-sensitive intensity elements is sensitive to the second particular wavelength or range of wavelengths generated by the second light emitting component, and the second light emitting component is operable to generate an encoded light onto the scene, the three-dimensional data being augmented by the encoded light generated onto the scene.

17. The optoelectronic system of claim 16, wherein the first light-emitting component is operable to generate modulated light, and the array of light-sensitive distance elements is operable to demodulate modulated light incident on the array of light-sensitive distance elements.

18. A method for capturing three-dimensional data with an optoelectronic system, the method comprising:
capturing an intensity image with an intensity imager;
establishing a region-of-interest within the intensity image;
capturing data with a distance measuring module;
mapping the data to the region-of-interest; and
generating the three-dimensional data with the intensity image and the data.

19. The method for capturing three-dimensional data of claim 18, further including:
capturing an additional intensity image with at least one additional intensity imager; and
generating the three-dimensional data with the intensity image and the data such that the block-matching protocol associated with the region-of-interest is augmented by the data.

20. The method for capturing three-dimensional data of claim 19, further including estimating disparity from the data captured by the distance measuring module and augmenting the block-matching protocol with the estimated disparity.
